(19) United States
(12) Patent Application Publication
(10) Pub. No.: US 2018/0215286 A1
(43) Pub. Date: Aug. 2, 2018

(54) VEHICLE CONTROL SYSTEM, VEHICLE CONTROL METHOD, AND VEHICLE CONTROL PROGRAM

(71) Applicant: HONDA MOTOR CO., LTD., Tokyo (JP)

(72) Inventor: Naotoshi Fujimoto, Utsunomiya-shi (JP)

(21) Appl. No.: 15/876,289

(22) Filed: Jan. 22, 2018

(30) Foreign Application Priority Data
Jan. 30, 2017 (JP) 2017-014026

(51) Int. Cl. B60N 2/02; B60R 16/037

(52) U.S. Cl. CPC B60N 2/0244; B60R 16/037; B60N 2/0232

(57) ABSTRACT

A vehicle control system includes an information acquisition unit configured to acquire time change information of which a value changes with time, a seat driving unit configured to drive at least a part of a seat on which an occupant of a vehicle is seated, and a seat control unit configured to control the seat driving unit on the basis of a change in the value of the time change information acquired by the information acquisition unit.

### CROSS-REFERENCE TO RELATED APPLICATION

Priority is claimed on Japanese Patent Application No. 2017-014026, filed Jan. 30, 2017, the content of which is incorporated herein by reference.

### BACKGROUND OF THE INVENTION

### Field of the Invention

The present invention relates to a vehicle control system, a vehicle control method, and a vehicle control program.

### Description of Related Art

In recent years, research on technology for automatically controlling at least one of acceleration, deceleration, and steering of a vehicle to execute automatic driving has been conducted. In this context, technology for adjusting a reclining angle of the seat between an automatic driving mode and a manual driving mode has been disclosed (see, for example, PCT International Publication No. WO2015/011866).

### SUMMARY OF THE INVENTION

However, in technology of a conventional method, it has been impossible to drive a seat in correspondence with a change in information that is not directly related to vehicle behavior. Accordingly, an occupant may not be properly notified of information obtained from the outside of the vehicle.

An aspect of the present invention has been made in view of such circumstances, and an objective of the aspect of the present invention is to provide a vehicle control system, a vehicle control method, and a vehicle control program capable of notifying an occupant of externally obtained information according to driving of a seat.

In order to achieve the above-described objective, the present invention adopts the following aspects.

(1) According to an aspect of the present invention, a vehicle control system includes an information acquisition unit configured to acquire time change information of which a value changes with time; a seat driving unit configured to drive at least a part of a seat on which an occupant of a vehicle is seated; and a seat control unit configured to control the seat driving unit on the basis of a change in the value of the time change information acquired by the information acquisition unit.

(2) In the above-described aspect (1), the time change information may be information of which a value changes independently of behavior of the vehicle.

(3) In the above-described aspect (1), the time change information may include an index value related to finance.

(4) In any one of the above-described aspects (1) to (3), the seat control unit may cause the seat driving unit to drive at least a part of the seat if the time change information satisfies a predetermined condition.

(5) In any one of the above-described aspects (1) to (4), the seat control unit may change a driving mode of the seat in the seat driving unit on the basis of the time change information.

(6) In the above-described aspect (5), the driving mode of the seat may include at least one of members, an amount of driving, and a driving speed of the seat to be driven.

(7) In the above-described aspect (6), the seat control unit may cause at least the part of the seat to be driven by associating an amount of change per time of the time change information and an amount of change per time of the amount of driving by the seat driving unit.

(8) In the above-described aspect (7), if the value of the time change information continuously increases, the seat control unit may iterate raising the seat at a first speed and lowering the seat at a second speed lower than the first speed.

(9) In the above-described aspect (7), if the value of the time change information continuously decreases, the seat control unit may iterate lowering the seat at a first speed and raising the seat at a second speed lower than the first speed.

(10) According to an aspect of the present invention, a vehicle control method includes acquiring, by a computer, time change information of which a value changes with time; and driving, by the computer, at least a part of a seat on which an occupant of a vehicle is seated on the basis of a change in the value of the acquired time change information.

(11) According to an aspect of the present invention, a vehicle control program causes a computer to: acquire time change information of which a value changes with time; and drive at least a part of a seat on which an occupant of a vehicle is seated on the basis of a change in the value of the acquired time change information.

According to the above-described aspect (1), (2), (10), or (11), the vehicle control system can notify the occupant of externally obtained information according to driving of the seat.

According to the above-described aspect (3), the occupant can ascertain a change in an index value even when the index value is not checked by a display screen, sound, or the like by driving the seat in accordance with the change in the index value related to finance.

According to the above-described aspect (4), the vehicle control system can allow the occupant to ascertain only necessary information from the seat.

According to the above-described aspect (5) or (6), the vehicle control system can cause the seat to be driven in association with the change in the value of the time change information.

According to the above-described aspect (7), (8), or (9), the occupant can feel as if the seat is continuously raised or lowered as a feeling obtained from the seat.

### BRIEF DESCRIPTION OF THE DRAWINGS

FIG. 1 is a configuration diagram of a vehicle system 1 including an automatic driving control unit 100 according to an embodiment.

FIG. 2 is a diagram illustrating a state in which a position and an orientation of a vehicle M relative to a traveling lane L1 are recognized by the own vehicle position recognition unit 122. FIG. 3 is a diagram illustrating a state in which a target trajectory is generated on the basis of a recommended lane.

FIG. 4 is a diagram illustrating an example of a configuration of a seat device 40.

FIG. 5 is a diagram illustrating an example of a setting screen 31A displayed on a display device 31 of a human machine interface (HMI) 30.

FIG. 6 is a diagram illustrating an example of information acquired by an information acquisition unit 160.

FIG. 7 is a diagram illustrating a state in which the seat device 40 is raised.

FIG. 8 is a diagram illustrating a state in which a reclining angle of a backrest portion 41B is adjusted.

FIG. 9 is a diagram illustrating a state in which an inclination angle of a footrest is adjusted.

FIG. 10 is a diagram illustrating driving the seat 41 by switching a driving speed.

FIG. 11 is a diagram illustrating an example of a notification screen 31B for notifying an occupant of the reason for moving the seat 41.

FIG. 12 is a flowchart illustrating an example of a seat driving process according to the embodiment.

### DETAILED DESCRIPTION OF THE INVENTION

Hereinafter, a vehicle control system, a vehicle control method, and a vehicle control program according to an embodiment will be described with reference to the drawings. In the embodiment, the vehicle control system is assumed to be applied to an automatically driven vehicle.

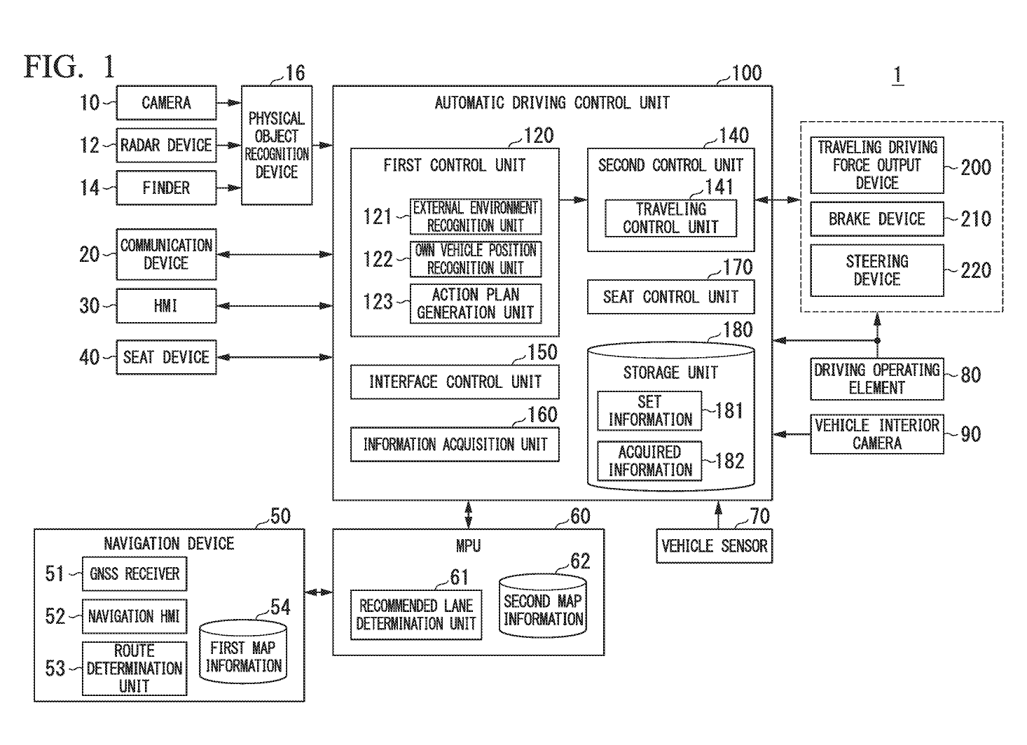

FIG. 1 is a configuration diagram of a vehicle system 1 including an automatic driving control unit 100 according to the embodiment. A vehicle equipped with the vehicle system 1 (hereinafter referred to as a “vehicle M”) is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a power generator connected to the internal combustion engine, or discharge power of a secondary battery or a fuel cell.

The vehicle system 1 includes, for example, a camera 10, a radar device 12, a finder 14, a physical object recognition device 16, a communication device 20, an HMI 30, a seat device 40, a navigation device 50, a micro-processing unit (MPU) 60, a vehicle sensor 70, a driving operating element 80, a vehicle interior camera 90, an automatic driving control unit 100, a traveling driving force output device 200, a brake device 210, and a steering device 220. These devices and apparatuses are connected to each other by a multiplex communication line such as a controller area network (CAN) communication line, a serial communication line, or a wireless communication network. Also, the configuration illustrated in FIG. 1 is merely an example, and a part of the configuration may be omitted or another configuration may be further added. For example, the “vehicle control system” includes some or all of the communication device 20, the HMI 30, the seat device 40, the vehicle sensor 70, and the automatic driving control unit 100.

For example, the camera 10 is a digital camera using a solid-state imaging device such as a charge coupled device (CCD) or a complementary metal oxide semiconductor (CMOS). One or more cameras 10 are attached to any positions on a vehicle equipped with the vehicle system 1 (hereinafter referred to as a “vehicle M”). If an image is captured in a forward direction, the camera 10 is attached to an upper portion of a front windshield, a rear surface of a room mirror, or the like. If an image is captured in a backward direction, the camera 10 is attached to an upper portion of a rear windshield, a back door, or the like. If the side is imaged, the camera 10 is attached to a door mirror or the like. For example, the camera 10 periodically and iteratively images the surroundings of the vehicle M.

The radar device 12 radiates radio waves such as millimeter waves around the vehicle M and detects at least a position (a distance and a direction) of a physical object by detecting radio waves (reflected waves) reflected by the physical object. One or more radar devices 12 are attached to any positions on the vehicle M. The radar device 12 may detect a position and speed of the physical object in a frequency modulated continuous wave (FM-CW) scheme.

The finder 14 is light detection and ranging or laser imaging detection and ranging (LIDAR) in which scattered light from irradiation light is measured and a distance to an object is detected. One or more finders 14 are attached to any positions on the vehicle M.

The physical object recognition device 16 performs a sensor fusion process on detection results from some or all of the camera 10, the radar device 12, and the finder 14 to recognize a position, a type, speed, and the like of a physical object. The physical object recognition device 16 outputs recognition results to the automatic driving control unit 100.

The communication device 20 communicates with an external device outside the vehicle by using, for example, a cellular network, a Wi-Fi network, Bluetooth (registered trademark), dedicated short range communication (DSRC), or the like. The external device is, for example, another vehicle existing around the vehicle M or various types of devices capable of performing communication via a wireless base station.

The HMI 30 presents various types of information to the occupant of an own vehicle M and receives an operation input by the occupant. The HMI 30 includes, for example, various types of display devices, speakers, microphones, buzzers, touch panels, switches, keys, and the like. The switches may be either a graphical user interface (GUI) switch or a mechanical switch. The same is true for the keys.

The seat device 40 is a seat on which the occupant of the vehicle M is seated and is a seat capable of being electrically driven. The seat device 40 includes a driver's seat seated for manually driving the vehicle M by using the driving operating element 80, a passenger seat beside the driver's seat, a rear seat behind the driver's seat and the passenger seat, and the like. In the following description, the “seat device 40” is at least one of the driver's seat, the passenger seat, and the rear seat, unless otherwise specified. A specific example of the seat device 40 will be described below.

For example, the navigation device 50 includes a global navigation satellite system (GNSS) receiver 51, a navigation HMI 52, and a route determination unit 53, and stores first map information 54 in a storage device such as a hard disk drive (HDD) or a flash memory. The GNSS receiver identifies a position of the vehicle M on the basis of a signal received from a GNSS satellite. The position of the vehicle M may be identified or supplemented by an inertial navigation system (INS) using an output of the vehicle sensor 70. The navigation HMI 52 includes a display device, a speaker, a touch panel, keys, and the like. The navigation HMI 52 may be partly or wholly shared with the above-described HMI 30. For example, the route determination unit 53 determines a route from the position of the vehicle M identified by the GNSS receiver 51 (or any input position) to a destination input by the occupant by using the navigation HMI 52 with reference to the first map information 54. The first map information 54 is, for example, information in which a road shape is expressed by a link indicating a road and a node connected by a link. The first map information 54 may include a curvature of a road, point of interest (POI) information, and the like. A route determined by the route determination unit 53 is output to the MPU 60. Also, the navigation device 50 may perform route guidance using the navigation HMI 52 on the basis of the route determined by the route determination unit 53. For example, the navigation device 50 may be implemented by a function of a terminal device such as a smartphone or a tablet terminal owned by the user. Also, the navigation device 50 may transmit a current position and a destination to a navigation server via the communication device 20 and acquire a route returned from the navigation server.

For example, the MPU 60 functions as the recommended lane determination unit 61, and stores second map information 62 in a storage device such as an HDD or a flash memory. The recommended lane determination unit 61 divides the route provided from the navigation device 50 into a plurality of blocks (for example, divides the route every 100 [m] with respect to a traveling direction of the vehicle), and determines a recommended lane for each block with reference to the second map information 62. The recommended lane determination unit 61 determines what number lane the vehicle travels on from the left. The recommended lane determination unit 61 determines the recommended lane so that the vehicle M can travel on a reasonable traveling route for traveling to a branching destination when there are branching points, merging points, or the like in the route.

The second map information 62 is map information which has higher accuracy than the first map information 54. For example, the second map information 62 includes information about a center of a lane, information about a boundary of a lane, or the like. Also, the second map information 62 may include road information, traffic regulations information, address information (an address/zip code), facility information, telephone number information, and the like. The road information includes information indicating types of road such as expressways, toll roads, national highways, and prefectural roads, information about the number of lanes on a road, a region of an emergency parking zone, a width of each lane, a gradient of a road, a position of a road (three-dimensional coordinates including longitude, latitude, and height), a curvature of a curve of a lane, positions of merging and branching points of lanes, signs provided on a road, and the like. The second map information 62 may be updated at any time by accessing another device by using the communication device 20.

The vehicle sensor 70 includes a sensor for acquiring information about vehicle behavior such as a vehicle speed sensor configured to detect speed of the vehicle M, an acceleration sensor configured to detect acceleration, a yaw rate sensor configured to detect angular speed around a vertical axis, or a direction sensor configured to detect a direction of the vehicle M. Also, the vehicle sensor 70 may include a sensor for acquiring information of which a value changes independently of the vehicle behavior. For example, information of which a value changes independently of the vehicle behavior includes an air temperature sensor, a humidity sensor, a rainfall sensor, and the like. The temperature sensor and the humidity sensor may respectively detect the temperature and the humidity outside the vehicle, and may detect the temperature and the humidity inside the vehicle. Also, the vehicle sensor 70 may include a seating sensor configured to detect whether an occupant is seated on the seat device 40 or the like.

For example, the driving operating element 80 includes an accelerator pedal, a brake pedal, a shift lever, a steering wheel, and other operating elements. A sensor configured to detect an amount of an operation or the presence or absence of an operation is attached to the driving operating element 80, and a detection result thereof is output to one or both of the automatic driving control unit 100 and a set of the traveling driving force output device 200, the brake device 210, and the steering device 220.

The vehicle interior camera 90 images an upper body around a face of the occupant seated on the seat device 40. A captured image of the vehicle interior camera 90 is output to the automatic driving control unit 100.

### [Automatic Driving Control Unit]

For example, the automatic driving control unit 100 includes a first control unit 120, a second control unit 140, an interface control unit 150, an information acquisition unit 160, a seat control unit 170, and a storage unit 180. Each of the first control unit 120, the second control unit 140, the interface control unit 150, the information acquisition unit 160, and the seat control unit 170 is implemented by a processor such as a central processing unit (CPU) executing a program (software). Also, some or all of the functional units of the first control unit 120, the second control unit 140, the interface control unit 150, the information acquisition unit 160, and the seat control unit 170 to be described below may be implemented by hardware such as a large scale integration (LSI), an application specific integrated circuit (ASIC), or a field-programmable gate array (FPGA) or may be implemented by cooperation of software and hardware.

Also, an example of an “automatic driving control portion” includes one or all of an external environment recognition unit 121, an own vehicle position recognition unit 122, and an action plan generation unit 123 of the first control unit 120, and a traveling control unit 141 of the second control unit 140 to be described below. The automatic driving control portion performs control so that at least one of acceleration/deceleration and steering of the vehicle M is automatically controlled and automatic driving of the vehicle M is executed.

For example, the first control unit 120 includes the external environment recognition unit 121, the own vehicle position recognition unit 122, and the action plan generation unit 123.

The external environment recognition unit 121 recognizes positions of surrounding vehicles, and states of velocity and acceleration thereof on the basis of information input from the camera 10, the radar device 12, and the finder 14 via the physical object recognition device 16. The position of a surrounding vehicle may be indicated by a representative point such as a center of gravity or a corner of the surrounding vehicle or may be indicated by a region represented by an outline of the surrounding vehicle. The “state” of the surrounding vehicle may include an acceleration or a jerk of the surrounding vehicle, or an “action state” thereof (for example, whether or not the vehicle is changing lane).

Also, the external environment recognition unit 121 may recognize positions of guardrails, electric poles, parked vehicles, pedestrians, and other physical objects in addition to surrounding vehicles. In this case, for example, the external environment recognition unit 121 determines whether or not an obstacle is present at a scheduled stop position of the vehicle M in automatic driving on the basis of a recognition result of the physical object recognition device 16. An obstacle includes other vehicles, pedestrians, other physical objects, and the like.

When it is determined that an obstacle is present at the scheduled stop position, the external environment recognition unit 121 instructs the action plan generation unit 123 to change a target trajectory.

For example, the own vehicle position recognition unit 122 recognizes a lane (a traveling lane) on which the vehicle M is traveling and a position and orientation of the vehicle M relative to the traveling lane. For example, the own vehicle position recognition unit 122 recognizes a traveling lane by comparing a pattern of a road dividing line (for example, an arrangement of a solid line and a broken line) obtained from the second map information 62 with a pattern of a road dividing line around the vehicle M recognized from the image captured by the camera 10. In this recognition, the position of the vehicle M acquired from the navigation device 50 and the processing result of the INS may be added.

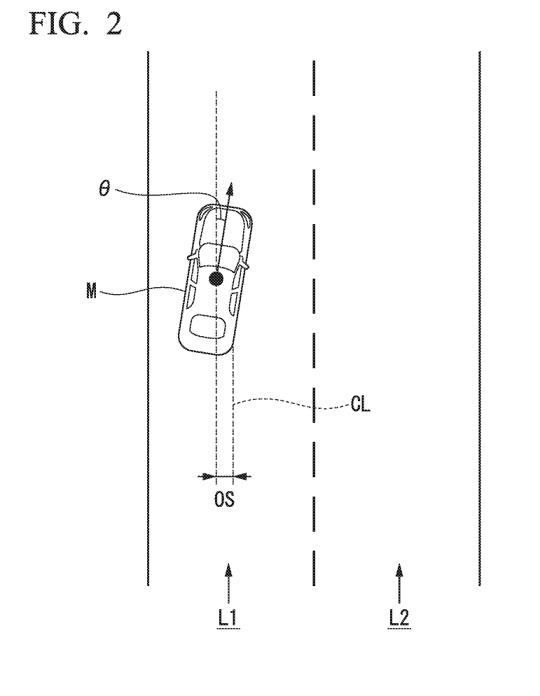

For example, the own vehicle position recognition unit 122 recognizes a position and an orientation of the vehicle M with respect to the traveling lane. FIG. 2 is a diagram illustrating a state in which a position and orientation of the vehicle M relative to a traveling lane L1 are recognized by the own vehicle position recognition unit 122. For example, the own vehicle position recognition unit 122 recognizes a deviation OS from a traveling lane center CL of a reference point (for example, a center of gravity) of the vehicle M and an angle θ formed with respect to a line connected to the traveling lane center CL in a traveling direction of the vehicle M as the position and the orientation of the vehicle M relative to the traveling lane L1. Alternatively, the own vehicle position recognition unit 122 may recognize a position of the reference point of the vehicle M or the like with respect to one side end of the traveling lane L1 as a position of the vehicle M relative to the traveling lane. The relative position of the vehicle M recognized by the own vehicle position recognition unit 122 is provided to the recommended lane determination unit 61 and the action plan generation unit 123.

The action plan generation unit 123 generates an action plan for the vehicle M to perform automatic driving to a destination or the like. For example, the action plan generation unit 123 determines events to be sequentially executed in the automatic driving to travel on a recommended lane determined by the recommended lane determination unit 61 and cope with a surrounding situation of the vehicle M. The events include, for example, a constant-speed traveling event for traveling on the same traveling lane at constant speed, a following traveling event for following a preceding vehicle, a lane change event, a merging event, a branching event, an emergency stop event, a handover event for performing switching to manual driving after automatic driving is completed, and the like. Also, during execution of these events, actions for avoidance may be planned on the basis of a surrounding situation of the vehicle M (presence of surrounding vehicles and pedestrians, lane narrowing due to road construction, or the like).

The action plan generation unit 123 generates a target trajectory in which the vehicle M travels in the future. For example, the target trajectory includes a velocity element. For example, the target trajectory is generated as a set of target points (trajectory points) at which the vehicle arrives at a plurality of future reference clock times after the future reference clock times are set for each predetermined sampling time (for example, about several tenths of a second [sec]). Thus, if a width between the trajectory points is wide, this indicates that the vehicle travels in a section between the trajectory points at high speed.

FIG. 3 is a diagram illustrating a state in which the target trajectory is generated on the basis of the recommended lane. As illustrated, the recommended lane is set to be convenient for traveling along a route to a destination.

When the vehicle approaches a predetermined distance before a switching point of the recommended lane (which may be determined in accordance with a type of the event), the action plan generation unit 123 activates a lane change event, a branching event, a merging event, or the like. If it becomes necessary to avoid an obstacle during the execution of one event, an avoidance trajectory is generated as illustrated.

For example, the action plan generation unit 123 generates a plurality of target trajectory candidates and selects an optimum target trajectory at that point in time on the basis of viewpoints of safety and efficiency.

For example, the second control unit 140 includes a traveling control unit 141. The traveling control unit 141 controls the traveling driving force output device 200, the brake device 210, and the steering device 220 so that the vehicle M passes through a target trajectory generated by the action plan generation unit 123 at a scheduled clock time.

The interface control unit 150 generates information to be output to the HMI 30. Also, the interface control unit 150 acquires information received by the HMI 30.

The information acquisition unit 160 acquires time change information of which a value changes with time by using the communication device 20. For example, the time change information is an index value related to finance. For example, the index value related to finance is at least one of stock price information, foreign exchange information, bond information, and real estate investment trust (REIT). For example, the stock price information includes an average stock price, and the like in addition to an individual stock price. The foreign exchange information includes a yen exchange rate. The bond information includes prices of government bonds and corporate bonds and the like. Also, the bond information may include futures and options, swap prices, and the like thereof.

Also, the time change information may be information such as temperature, humidity, rainfall, or the like obtained as a detection result from the vehicle sensor 70 or as a reception result from a server device that distributes weather information. Also, the time change information may be the number of participants in a chat room or an online game, for example, using a social networking service, obtained from a predetermined server device.

The seat control unit 170 drives at least a part of the seat device 40 on which the occupant of the vehicle M is seated on the basis of information acquired by the information acquisition unit 160. Also, the seat control unit 170 may move the seat 41 so that the occupant is at a seat position during manual driving on the basis of an instruction of the occupant as an inherent function.

The storage unit 180 is a storage device such as a hard disk drive (HDD), a flash memory, a random access memory (RAM), a read only memory (ROM), or the like. For example, set information 181 and acquired information 182 are stored in the storage unit 180.

The traveling driving force output device 200 outputs a traveling driving force (a torque) to driving wheels for the vehicle to travel. For example, the traveling driving force output device 200 includes a combination of an internal combustion engine, an electric motor, a transmission, and the like, and an ECU configured to control them. The ECU controls the above-described components in accordance with information input from the traveling control unit 141 or information input from the driving operating element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the traveling control unit 141 or the information input from the driving operating element 80 so that a brake torque according to a braking operation is output to each wheel. The brake device 210 may include a mechanism configured to transfer the hydraulic pressure generated by an operation of the brake pedal included in the driving operating element 80 to the cylinder via a master cylinder as a backup. Also, the brake device 210 is not limited to the above-described configuration and may be an electronically controlled hydraulic brake device configured to control the actuator in accordance with information input from the traveling control unit 141 and transfer the hydraulic pressure of the master cylinder to the cylinder. Also, the brake device 210 may include brake devices of a plurality of systems in consideration of safety.

For example, the steering device 220 includes a steering ECU and an electric motor.

For example, the electric motor changes a direction of steerable wheels by applying a force to a rack and pinion mechanism. The steering ECU drives the electric motor in accordance with the information input from the traveling control unit 141 or the information input from the driving operating element 80 to change the direction of the steerable wheels.

[Seat Control Based on Change with Time]

Hereinafter, seat control for driving the seat device 40 on the basis of information that changes with time will be described. For example, the vehicle M of the embodiment receives selection of time change information, acquires the received information from the external device continuously (for example, at predetermined times), and drives at least a part of the seat device 40 in accordance with the acquired information.

### [Seat Device]

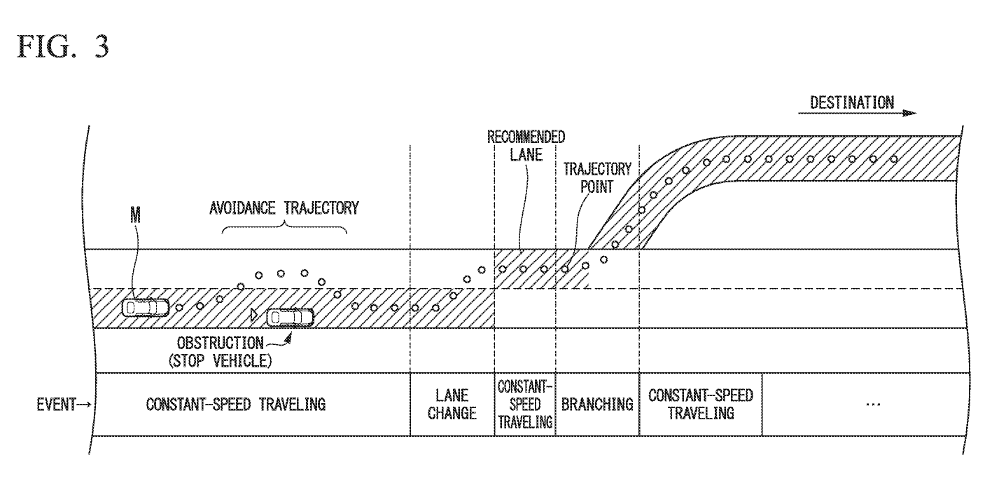

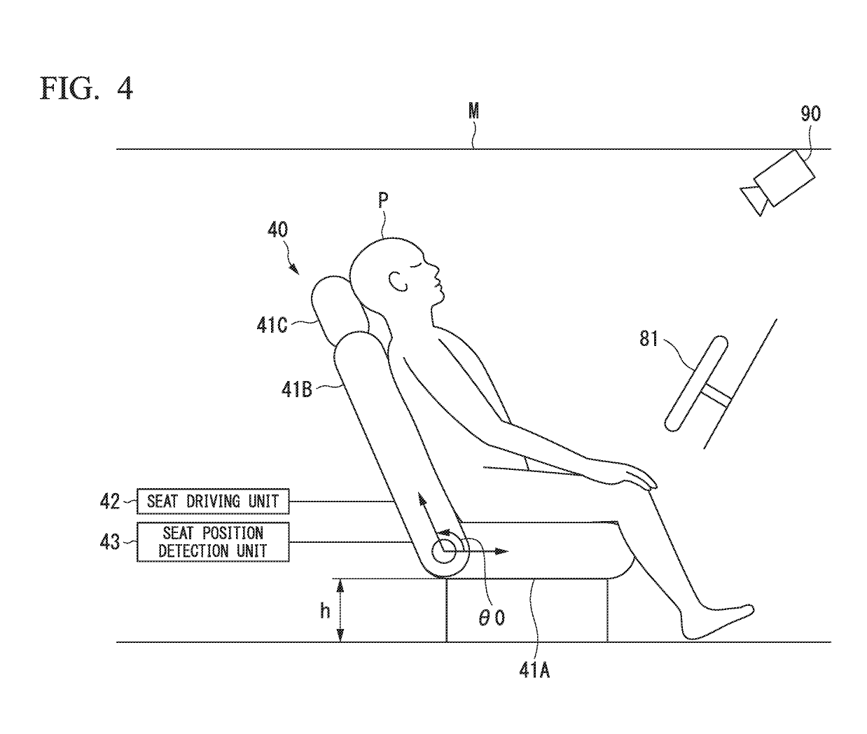

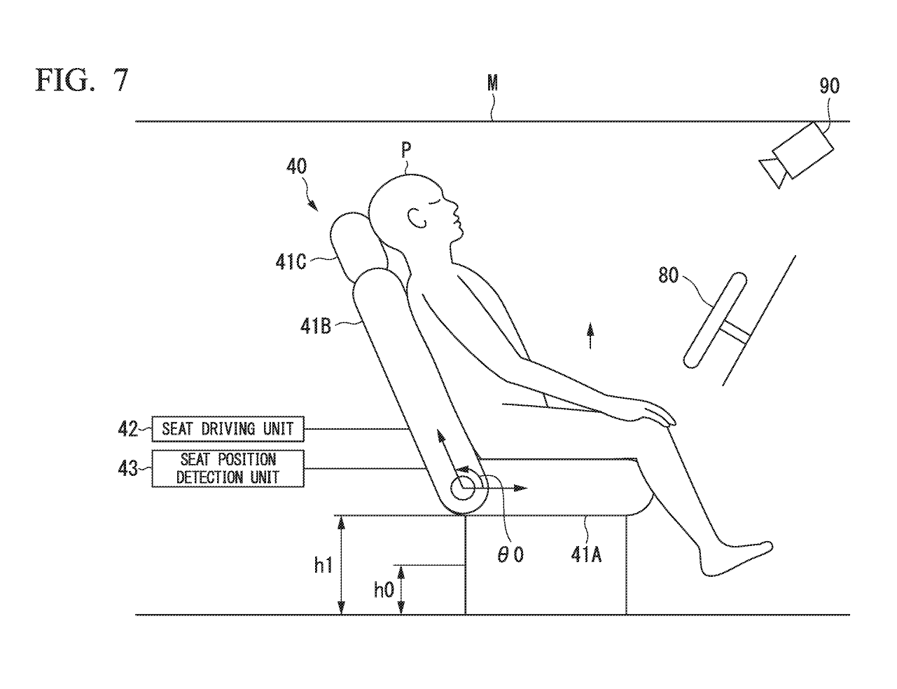

First, a specific example of the seat device 40 of the embodiment will be described. FIG. 4 is a diagram illustrating an example of a configuration of the seat device 40. For example, the seat device 40 includes a seat 41, a seat driving unit 42, and a seat position detection unit 43. For example, the seat 41 includes a seat portion (a seat cushion) 41A, a backrest portion (a seat back) 41B, and a headrest 41C. In the example of FIG. 4, the steering wheel 81, which is one of driving operating elements 80 provided within the vehicle M, and the vehicle interior camera 90 are schematically shown. The same is true for FIGS. 7 to 9 to be described below.

For example, the seat driving unit 42 moves the seat 41 in an up/down direction of the vehicle M.

For example, the seat driving unit 42 adjusts a height h illustrated in FIG. 4 by vertically driving the seat portion 41A through a driving unit such as an actuator and raising or lowering the seat 41 on which an occupant P is seated.

Also, the seat driving unit 42 may move the seat device 40 in a forward/backward/left/right direction. Also, the seat driving unit 42 may adjust an angle (a reclining angle) formed by the seat portion 41A and the backrest portion 41B and the like through the driving unit.

The seat position detection unit 43 detects an up/down position, a position in a forward/backward/left/right direction, a reclining angle, and the like of the seat 41. The seat position detection unit 43 outputs a detection result to the seat control unit 170.

### [Setting of Information to be Acquired]

The interface control unit 150 outputs a screen for allowing the occupant P to set information to be linked with driving of the seat to the HMI 30. FIG. 5 is a diagram illustrating an example of a setting screen 31A displayed on the display device 31 of the HMI 30. The display device 31 is a liquid crystal display (LCD), an organic electro luminescence (EL) display device, or the like. For example, the display device 31 is a touch panel type display device having a function of displaying an image and a function of receiving an approaching position and operation details of an operator's finger on a display surface.

If an operation of setting notification information to be provided to the occupant P is received by the HMI 30, the interface control unit 150 displays the setting screen 31A illustrated in FIG. 5 on the display device 31. On the setting screen 31A, for example, an item selection area 31Aa for allowing the occupant P to select an item of notification to be provided by the seat device 40 and an execution approval/disapproval selection area 31Ab for allowing the occupant P to indicate or cancel execution of a selected item are set.

In the illustrated example, GUI switches for “stock price,” “exchange rate,” “temperature,” and the like are displayed in the item selection area 31Aa. The interface control unit 150 stores selected details as the set information 181 in the storage unit 180 if the selection of an item by a touch operation of the occupant P among items is performed and then an operation of selecting a GUI switch of “OK” in the execution approval/disapproval selection area 31Ab is received from the occupant P. Also, the interface control unit 150 may associate selected details with at least one of identification information of the occupant P (for example, an occupant ID) or identification information of the seat device 40 (a seat ID) in the vehicle M and store an association result as the set information 181 in the storage unit 180. Also, if an operation of selecting a GUI switch of “cancel” in the execution approval/disapproval selection area 31Ab is received, the interface control unit 150 ends the display of the setting screen 31A.

Also, if an operation of selecting “stock price,” “exchange rate,” or “weather” is received, the interface control unit 150 may display a detailed setting screen for performing further detailed setting on the display device 31. In this case, for example, if the operating of selecting “stock price” is received, the interface control unit 150 further displays a screen for enabling at least one of an average stock price, a designated stock, and a stock for which the occupant P is investing individually to be selected on the display device 31.

Also, the interface control unit 150 may receive setting of information such as a stock price of a stock owned by the occupant P and bonds owned by the occupant P. Also, the interface control unit 150 may display a screen for setting a total (a portfolio) of financial assets owned by the occupant P as the detailed setting screen on the display device 31. Thereby, a current amount of money, a percentage change from the previous day, and the like of the portfolio of the occupant P can be reflected in the driving of the seat 41.

Also, for example, if the operation of selecting “temperature” is received, the interface control unit 150 may display a setting screen capable of setting a country, a region, and the like as well as the temperature of a current position of the vehicle.

The information acquisition unit 160 inquiries of the external device about the information stored as the set information 181 by using the communication device 20 and acquires corresponding information. For example, the external device is an information providing device managed by a securities company, an information providing device managed by an information provider configured to provide securities news, or the like when securities information is acquired. Also, if information of temperature, humidity, or the like is acquired, the external device may be a server device of a government agency configured to manage weather, or a distribution device configured to distribute weather news and the like.

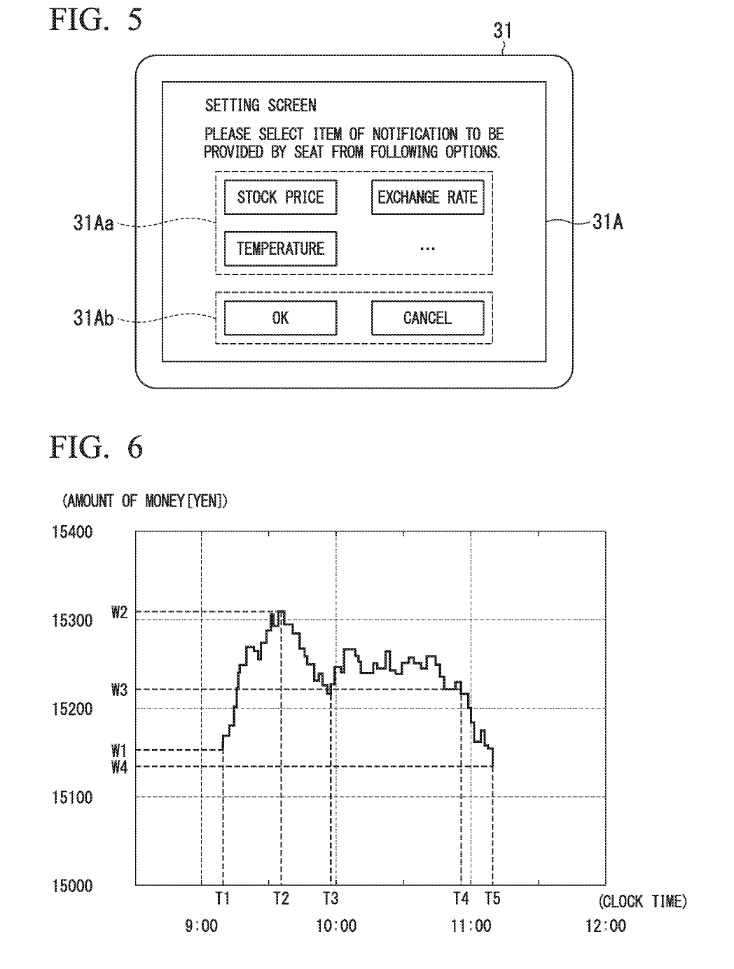

FIG. 6 is a diagram illustrating an example of information acquired by the information acquisition unit 160. In the illustrated example, the horizontal axis represents a clock time and the vertical axis represents an amount of money (yen). In the illustrated example, an average stock price acquired from the information providing device capable of performing communication via the communication device 20 is shown. The information acquisition unit 160 continuously acquires the average stock price information and outputs the acquired information to the seat control unit 170. Also, the information acquisition unit 160 causes the storage unit 180 to store information acquired from the external device as the acquired information 182.

The seat control unit 170 drives the seat device 40 on the basis of the acquired information 182. Also, if the acquired information 182 satisfies a predetermined condition, the seat control unit 170 may cause the seat driving unit to drive at least a part of the seat 41. For example, the seat control unit 170 may be configured to drive the seat 41 if an amount of change in values at predetermined time intervals in the acquired information 182 exceeds a threshold value and prevent the seat 41 from being driven if the amount of change is less than or equal to the threshold value.

For example, in the example of FIG. 6, between a clock time T1 and a clock time T2, the amount of money has increased from W1 to W2. In this case, the seat control unit 170 performs control for causing the seat driving unit 42 to raise the seat 41 in accordance with the increase in the amount of money. Between the clock time T2 and a clock time T3, the amount of money has decreased from W2 to W3. In this case, the seat control unit 170 performs control for causing the seat driving unit 42 to lower the seat 41 in accordance with the decrease in the amount of money.

Also, between the clock time T3 and a clock time T4, a small increase and decrease are iterated between the amounts of money W2 and W3. In this case, the seat control unit 170 may be configured to prevent the seat from being driven within a predetermined range (for example, the difference within a predetermined time is within 50 yen). Thereby, because the seat control unit 170 can minimize small up/down movements of the seat 41, it is possible to reduce the burden due to the up/down movement of the occupant P seated on the seat 41. Also, the seat control unit 170 may cause the seat 41 to be raised and lowered in small amounts in correspondence with the increase and decrease in the amount of money regardless of the above-described condition such as within the predetermined range.

Also, between the clock time T4 and a clock time T5, an amount of money W3 has decreased to W4. In this case, the seat control unit 170 performs control for causing the seat driving unit 42 to lower the seat 41 in accordance with the decrease in the amount of money.

FIG. 7 is a diagram illustrating a state in which the seat device 40 is raised. For example, if driving of the seat is started, the seat control unit 170 performs control for causing the seat driving unit 42 to move the seat 41 to a height h0 of an initial value at which upper and lower sides of the seat 41 can be moved thereafter. For example, this start timing is a case in which an operation indicating the start of seat driving of the embodiment by the occupant P of the vehicle M is received.

Thereafter, when the average stock price increases, the seat control unit 170 performs control for causing the seat driving unit 42 to raise the seat 41 in accordance with an increase in the amount of money. In the example of FIG. 7, the seat 41 is raised from a height h0 to a height h1. Thereby, for example, the occupant P can acquire information indicating that the average stock price has increased from the movement of the seat device 40 without having to view the screen of the display device 31 of the HMI 30.

Also, when the average stock price decreases, the seat control unit 170 performs control for causing the seat driving unit 42 to lower the seat 41 in correspondence with a decrease in the amount of money. Thereby, the occupant P can acquire information indicating that the average stock price has decreased from the movement of the seat device 40 without having to view the screen of the display device 31 of the HMI 30.

If the seat 41 is moved up/down, the seat control unit 170 performs control so that the seat 41 moves within a range of up/down driving in consideration of preset safety. In this case, for example, the seat control unit 170 sets a range in which the seat 41 can be raised or lowered with respect to the height h0 of the initial value and performs control for causing the seat 41 to be driven on the basis of an amount of movement with respect to an amount of change in the average stock price within the set range.

Also, the seat control unit 170 may perform control for changing the driving mode of the seat 41 in the seat driving unit 42 on the basis of the acquired information 182. For example, the driving mode of the seat 41 includes at least one of members, an amount of driving, and a driving speed of the driven seat 41. For example, the members of the seat 41 are the seat portion 41A, the backrest portion 41B, and the headrest 41C.

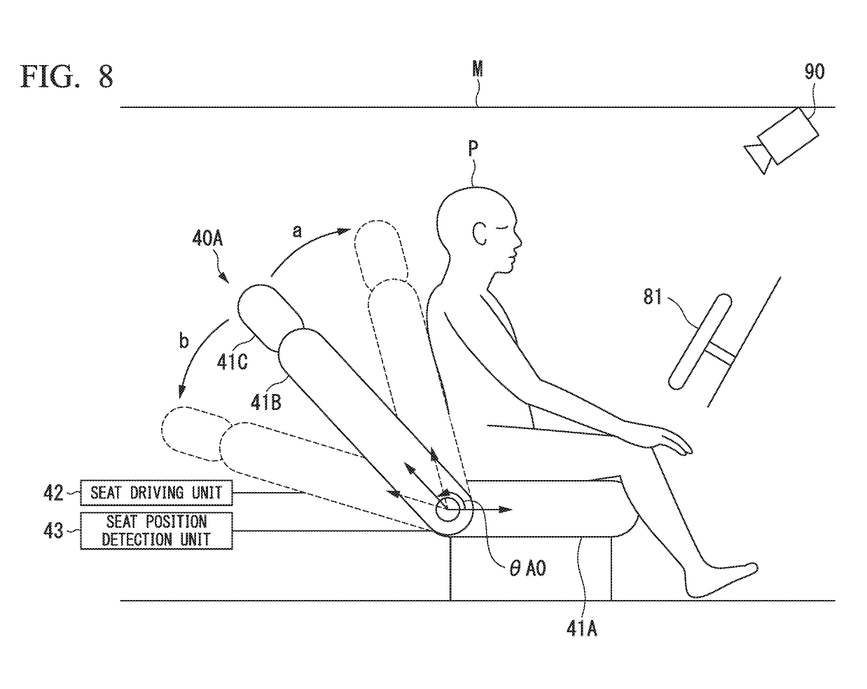

FIG. 8 is a diagram illustrating a state in which the reclining angle of the backrest portion 41B is adjusted. The seat control unit 170 adjusts a reclining angle at the seat portion 41A and the backrest portion 41B of the seat device 40A with reference to an initial value angle θA0 in accordance with a value that changes with time acquired by the information acquisition unit 160.

For example, if the average stock price has increased as an example of the acquired information 182, the seat control unit 170 performs control in which the seat driving unit 42 adjusts the reclining angle in correspondence with an increase in an amount of money and moves the backrest portion 41B in an upward direction (a direction of an arrow a of FIG. 8). Also, if the average stock price has decreased, the seat control unit 170 performs control in which the seat driving unit 42 adjusts the reclining angle in correspondence with a decrease in an amount of money and moves the backrest portion 41B in a horizontal direction (a direction of an arrow b of FIG. 8). Thereby, for example, the occupant P can acquire information indicating that the average stock price has increased or decreased from the movement of the backrest portion 41B without having to view the screen of the display device 31 of the HMI 30.

Also, the member of the seat 41 may be a footrest (ottoman) or an armrest.

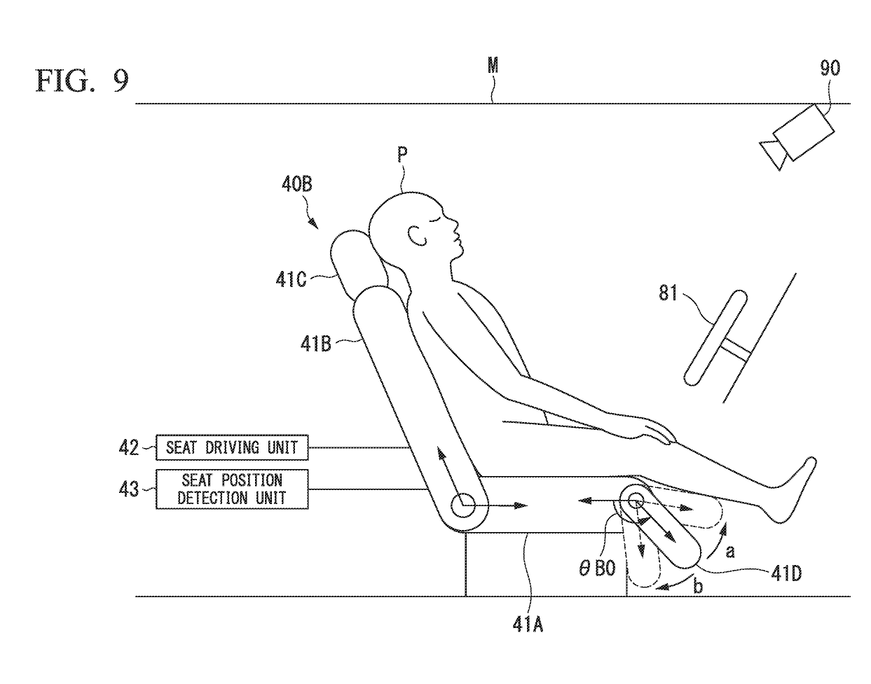

FIG. 9 is a diagram illustrating a state in which an inclination angle of the footrest is adjusted. In the example of FIG. 9, the seat 41 of the seat device 40B is provided with a footrest 41D in addition to the seat portion 41A, the backrest portion 41B, and the headrest 41C. The seat control unit 170 adjusts an inclination angle of the footrest 41D of the seat device 40B with reference to an initial value angle θB0 on the basis of the acquired information 182.

For example, if the average stock price has increased as an example of the acquired information 182, the seat control unit 170 performs control in which the seat driving unit 42 adjusts the inclination angle in correspondence with information of an amount of money and moves the footrest 41D in a horizontal direction (a direction of an arrow a of FIG. 9). Also, if the average stock price has decreased, the seat control unit 170 performs control in which the seat driving unit 42 adjusts the inclination angle in correspondence with a decrease in the amount of money and moves the footrest 41D in a direction in which the footrest 41D is stored in a lower portion of the seat portion 41A (a direction of an arrow b of FIG. 9). Thereby, for example, the occupant P can acquire information indicating that the average stock price has increased or decreased from the movement of the footrest 41D without having to view the screen of the display device 31 of the HMI 30.

Also, the seat control unit 170 may perform control in which the above-described raising and lowering of the seat portion 41A, the adjustment of the reclining angle, and the adjustment of the inclination angle of the footrest are combined. For example, the seat control unit 170 may perform control for changing a member to be moved in accordance with a type of information acquired by the information acquisition unit 160.

Also, the seat control unit 170 may drive at least a part of the seat 41 by associating an amount of change per time of the time change information and an amount of change per time of an amount of driving by the seat driving unit 42. For example, if the value of the time change information continuously increases, the seat control unit 170 may iterate raising the seat 41 at a first speed and lowering the seat 41 at a second speed lower than the first speed. In this case, although it is preferable that the first speed be a speed that is sufficient for the occupant to recognize the raising of the seat 41 and the second speed be a speed that is sufficient for the occupant not to recognize the lowering of the seat 41, the present invention is not limited thereto. For example, the seat control unit 170 performs control for causing the seat driving unit 42 to drive the seat 41 by performing switching between a driving speed that is sufficient for the occupant P to recognize a change and a driving speed that is sufficient for the occupant P not to recognize a change.

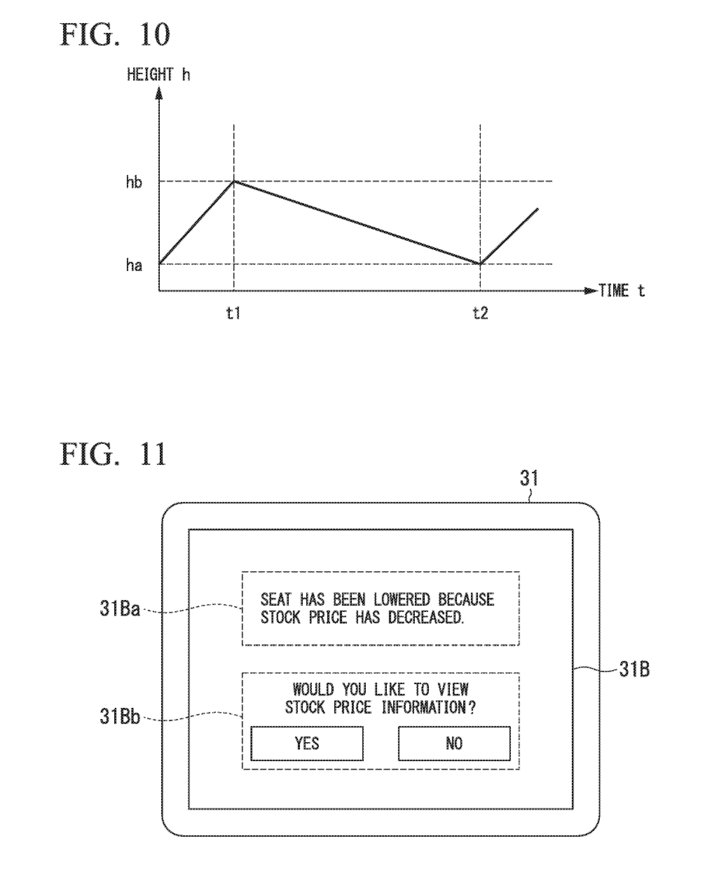

FIG. 10 is a diagram illustrating driving of the seat 41 by switching the driving speed. In the example of FIG. 10, the horizontal axis represents a time t and the vertical axis represents a height h of the seat 41.

For example, the seat control unit 170 performs control for causing the seat 41 to be raised to the vicinity of an upper limit of the height at a speed recognized by the occupant P and then lowered at a speed which is not recognized by the occupant P if the value continuously increases with time and causing the seat 41 to be raised to the vicinity of the upper limit at a speed recognized by the occupant P when the height is near a lower limit thereof.

For example, in the example of FIG. 10, a height ha indicates the vicinity of the lower limit of the height at which driving is possible, and a height hb indicates the vicinity of the upper limit of the height at which driving is possible. The seat control unit 170 performs control in which the seat driving unit 42 raises the seat 41 from the height ha to the height hb from a time t0 to a time t1. In this case, the seat control unit 170 performs control in which the seat driving unit 42 drives the seat 41 at a driving speed that is sufficient for the occupant P to recognize the raising of the seat 41. Also, the seat control unit 170 performs control in which the seat driving unit 42 lowers the seat 41 from the height hb to the height ha between the time t1 and a time t2. In this case, the seat control unit 170 performs control in which the seat driving unit 42 drives the seat at a slow driving speed that is sufficient for the occupant P not to recognize the lowering of the seat 41. Also, after the time t2, the seat control unit 170 performs control in which the seat driving unit 42 raises the seat 41 at the same speed as a moving speed from the time t0 to the time t1 again.

Thereby, because the occupant P recognizes the movement of the seat 41 only when the seat 41 is raised, the occupant P can feel as if the seat 41 is continuously raised as a feeling obtained from the seat 41.

Likewise, if the value of the time change information continuously decreases, the seat control unit 170 iterates lowering the seat 41 at the first speed and raising the seat 41 at the second speed lower than the first speed. In this case, although it is preferable that the first speed be a speed that is sufficient for the occupant to recognize the lowering of the seat 41 and the second speed be a speed that is sufficient for the occupant not to recognize the lowering of the seat 41, the present invention is not limited thereto. For example, if the value continuously decreases with time, the seat control unit 170 may perform control for lowering the seat 41 at a speed recognized by the occupant P until the seat position is close to the lower limit thereof and then raising the seat 41 at a speed unrecognized by the occupant P and lowering the seat 41 at a speed recognized by the occupant P until the seat 41 is close to the lower limit thereof again when the seat position is close to the upper limit thereof. Thereby, the occupant P can feel as if the seat 41 is continuously lowered as a feeling obtained from the seat 41.

Also, the seat control unit 170 may perform control for adjusting to a driving speed recognized or a driving speed unrecognized by the occupant P in a bodily sensation in accordance with an expression of the face of the occupant P obtained from the vehicle interior camera 90 when the seat 41 is driven, a behavior of the occupant P, or the like. Also, the seat control unit 170 may perform control for causing the seat driving unit 42 to drive the seat 41 by performing switching between an amount of driving recognized by the occupant P and an amount of driving unrecognized by the occupant in place of (or in addition to) the recognized driving speed or the unrecognized driving speed described above.

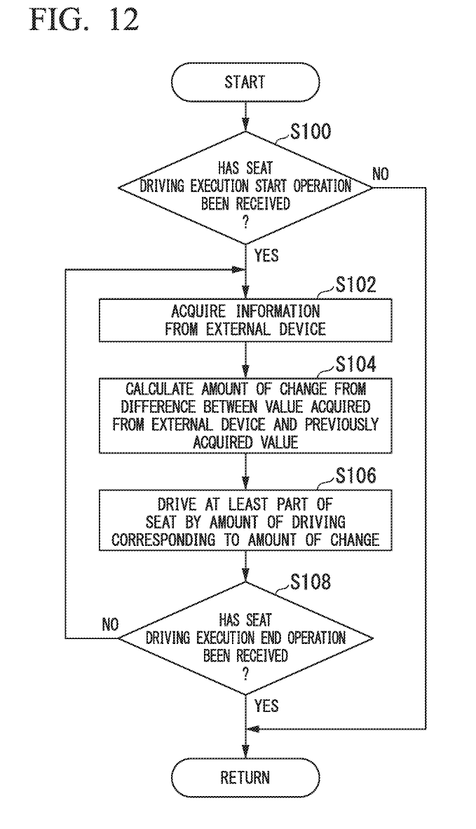

Also, for example, if the seat 41 is driven in correspondence with a stock price or the like, the seat control unit 170 may cause the interface control unit 150 to output information about the reason for driving to the HMI 30. FIG. 11 is a diagram illustrating an example of a notification screen 31B for notifying the occupant P of the reason for moving the seat 41. In the illustrated example, for example, the notification screen 31B displays a movement reason display area 31Ba and a GUI switch display area 31Bb. The interface control unit 150 displays notification information about a movement direction and an amount of movement when the seat control unit 170 moves the seat 41 in the movement reason display area 31Ba.

Also, the interface control unit 150 causes the GUI switch display area 31Bb to display a GUI switch for inquiring of the occupant P about whether or not to display detailed information about a cause for moving the seat 41. Also, if an operation input by the occupant P is received, the interface control unit 150 acquires the detailed information about the cause for moving the seat 41 from the acquired information 182 and causes the display device 31 to display the acquired detailed information.

For example, in the example of FIG. 11, the interface control unit 150 sets a GUI switch for allowing the user to select whether or not to view stock price information in the display device 31 and causes the display device 31 to display detailed information (for example, information illustrated in FIG. 6) if the display device 31 receives an operation of selecting a YES button among the GUI switches. Thereby, the occupant P can easily ascertain the detailed information about the driving of the seat 41. Also, because the occupant P can ascertain the reason for driving the seat 41, the occupant P can be relieved. Also, the occupant P can check the reason for driving the seat at a timing at which the display device 31 can be viewed with an easy mind, for example, when the vehicle M has stopped or the like.

Also, in the embodiment, the time change information acquired from the external device may include traffic information and height information. The traffic information is, for example, traffic jam information about a traveling destination of a traveling lane of the vehicle M. In this case, the seat control unit 170 performs control for raising the seat 41 in accordance with a traffic jam distance when the head of the traveling lane is congested. Thereby, the occupant P can view the way ahead in a traffic jam. Also, the seat control unit 170 acquires information about a height of a point at which the vehicle M is traveling, and performs control for raising or lowering the seat 41 on the basis of the acquired height. Thereby, the occupant P can raise the position of the seat at a high height point so that surrounding scenery can be seen from above.

Also, the seat control unit 170 may perform different drive control in the seat device 40 of the driver seat and the seat device other than the driver's seat in the seat device 40 of the vehicle M. For example, the seat control unit 170 determines whether or not the seat device 40 is the driver's seat and performs the above-described driving control of the seat 41 if the driving mode of the vehicle M is automatic driving in the case of the driver's seat. Thereby, when the occupant P manually drives the vehicle M, it is possible to minimize the obstruction of driving by the above-described seat driving.

Also, the seat control unit 170 may perform control for adjusting a range in which the seat 41 is movable on the basis of at least one of acceleration/deceleration and steering during automatic driving of the vehicle M. In this case, the seat control unit 170 performs control for narrowing the range in which the seat 41 is movable, for example, if the vehicle M is traveling at a speed greater than or equal to a threshold value. Also, the seat control unit 170 may perform control so that the seat is not driven when a steering angle of a steering wheel is greater than or equal to a threshold value. Thereby, safe seat driving can be implemented for each seat device 40 in accordance with the traveling state of the vehicle M.

When the seat driving in the embodiment is performed in the seat device 40 other than the driver's seat, it is only necessary for the vehicle M to have a configuration for manual driving. In this case, the configuration of the first control unit 120 or the second control unit 140 in the vehicle control system may be omitted.

### [Vehicle Control Process]

Hereinafter, various types of vehicle control by the vehicle system 1 according to the embodiment will be described. FIG. 12 is a flowchart illustrating an example of the seat driving process according to the embodiment. In the following description, information to be linked with the driving of the seat device 40 is assumed to be set on the setting screen 31A described above.

First, the interface control unit 150 determines whether or not a seat driving execution start operation based on a change in a value of external information has been received from the occupant P by the display device 31 (step S100). When the seat driving execution start operation has been received, the information acquisition unit 160 acquires corresponding information from the external device capable of acquiring the set information (step S102). Next, the seat control unit 170 calculates an amount of change from a difference between a value acquired by the information acquisition unit 160 and a previously acquired value (step S104), and performs control for driving at least a part of the seat 41 by an amount of driving according to the calculated amount of change (step S106).

Next, the interface control unit 150 determines whether or not a seat driving execution end operation has been received by the HMI 30 (step S108). If a seat driving execution end operation has not been received, the process returns to step S102. Also, if a seat driving execution end operation has been received, the process of this flowchart is ended. If a seat driving execution start operation has not been received, the process of this flowchart is ended as it is.

According to the vehicle control system, the vehicle control method, and the vehicle control program in the above-described embodiment, the vehicle control system can notify the occupant P of externally obtained information by driving a seat.

More specifically, according to the embodiment, the vehicle control system sets information capable of changing up/down with time for each seat device 40 of the vehicle M, thereby performing seat driving according to information acquired for each seat device 40. Accordingly, for example, it is possible to enhance entertainment in a vehicle interior because the driving of the seat 41 of a passenger of the vehicle M is viewed and the seat 41 on which an occupant is seated is also driven.

Also, according to the embodiment, the occupant can ascertain financial information in real time and perform appropriate asset management by driving the seat device 40 on the basis of information including an index value related to finance. Also, according to the embodiment, the occupant can ascertain a state of the outside of the vehicle without viewing it by driving the seat device 40 on the basis of information such as temperature, humidity, and rainfall. Also, according to the embodiment, the occupant can participate at an appropriate timing at which a chat or a game becomes exciting by driving the seat device 40 in accordance with the number of participants in a chat room, an online game, or the like.

Although modes for carrying out the present invention have been described above using embodiments, the present invention is not limited to these embodiments at all and various modifications and substitutions can be made without departing from the spirit and scope of the present invention.

What is claimed is:

1. A vehicle control system comprising:
an information acquisition unit configured to acquire time change information of which a value changes with time;
a seat driving unit configured to drive at least a part of a seat on which an occupant of a vehicle is seated; and
a seat control unit configured to control the seat driving unit on the basis of a change in the value of the time change information acquired by the information acquisition unit.

2. The vehicle control system according to claim 1, wherein the time change information is information of which a value changes independently of behavior of the vehicle.

3. The vehicle control system according to claim 1, wherein the time change information includes an index value related to finance.

4. The vehicle control system according to claim 1, wherein the seat control unit causes the seat driving unit to drive at least a part of the seat if the time change information satisfies a predetermined condition.

5. The vehicle control system according to claim 1, wherein the seat control unit changes a driving mode of the seat in the seat driving unit on the basis of the time change information.

6. The vehicle control system according to claim 5, wherein the driving mode of the seat includes at least one of members, an amount of driving, and a driving speed of the seat to be driven.

7. The vehicle control system according to claim 6, wherein the seat control unit causes at least the part of the seat to be driven by associating an amount of change per time of the time change information and an amount of change per time of the amount of driving by the seat driving unit.

8. The vehicle control system according to claim 7, wherein, if the value of the time change information continuously increases, the seat control unit iterates raising the seat at a first speed and lowering the seat at a second speed lower than the first speed.

9. The vehicle control system according to claim 7, wherein, if the value of the time change information continuously decreases, the seat control unit iterates lowering the seat at a first speed and raising the seat at a second speed lower than the first speed.

10. A vehicle control method comprising:
acquiring, by a computer, time change information of which a value changes with time; and
driving, by the computer, at least a part of a seat on which an occupant of a vehicle is seated on the basis of a change in the value of the acquired time change information.

11. A vehicle control program for causing a computer to:
acquire time change information of which a value changes with time; and
drive at least a part of a seat on which an occupant of a vehicle is seated on the basis of a change in the value of the acquired time change information.
